(19) United States
(12) Patent Application Publication
(10) Pub. No.: US 2026/0133284 A1
(43) Pub. Date: May 14, 2026

(54) METHOD, TRANSCEIVER STATION, IDENTIFICATION MEANS AND SYSTEM FOR IDENTIFYING AN OBJECT

(71) Applicant: DEUTSCHES ZENTRUM FÜR LUFT- UND RAUMFAHRT E.V., 53227 Bonn (DE)

(72) Inventors: Hüseyin VURAL, Stuttgart (DE); Denise KEIL, Stuttgart (DE); Nils BARTELS, Stuttgart (DE); Daniel HAMPF, Stuttgart (DE)

(73) Assignee: DEUTSCHES ZENTRUM FÜR LUFT- UND RAUMFAHRT E.V., 53227 Bonn (DE)

(21) Appl. No.: 18/703,405

(22) PCT Filed: Feb. 25, 2022
(86) PCT No.: PCT/EP2022/054892

§ 371 Date: Apr. 22, 2024

(51) Int. Cl. G01S 7/48; G01S 7/484; G01S 7/4863; G01S 7/487; G01S 7/499

(52) U.S. Cl. CPC G01S 7/4802; G01S 7/484; G01S 7/4863; G01S 7/4876; G01S 7/499

(57) ABSTRACT

A method for identifying an object, a transceiver station, an identification arrangement and a system for identifying the object are provided and include a transceiver station with a source for generating a pulse train from pulses of electromagnetic radiation and an identification arrangement arranged on the object. The source sends pulses from the pulse train in the direction of the object. A receive signal is transmitted back from the identification arrangement to the transceiver station in response to each transmission signal. Two polarization states of the received signal offset in time by the transit time of the received signal from the object to the transceiver station are detected with two detectors and an actual identification pattern of the object is formed by aggregating the intensities of the polarization states of several successive received signals. A time shift of the receive signals relative to a trigger signal synchronized with the pulse train of the source is also detected.

### BACKGROUND AND SUMMARY

The invention relates to a method for identifying an object, in particular a satellite in space, a transceiver station for identifying an object and an identification means, a system for identifying an object, in particular a satellite in space, and a computer program product and a data processing system to carry out such a method.

Due to the increasing use of space, including commercially, there is great interest in methods for ground-based detection of space objects. This simplifies not only the operation of satellites, but also the space position detection, the so-called “Space Situational Awareness”, the collision avoidance and the retrieval of satellites without precise trajectory data. The largest contribution to space situational awareness currently comes from radar measurements. Radar measurements can directly image large satellites based on their external dimensions. However, this is generally not possible for small satellites, such as so-called CubeSats, especially since numerous satellites are sometimes deployed into space during a single rocket launch. The operators of these small satellites often only receive orbit data with a delay and these are not always associated with a specific satellite.

There is currently no standard technology to make it easier to identify space objects from earth. An existing possibility is to equip satellites with radio transmitters in combination with GPS receivers. These radio signals can be received using large radio telescopes. An alternative is the use of pulsed, coded optical laser diodes on the satellite and the detection using a telescope and single photon detector at a ground station.

DE 102013101730 A1 describes a method for unique identification of an object, in which a unique identification means is arranged on or in an object designed as a spacecraft. A transmit signal containing electromagnetic waves is sent from a transmission station to the identification means of the spacecraft located in space. An identification signal comprising electromagnetic waves sent back by the identification means of the spacecraft in response to the transmit signal is received in a receiving station. The spacecraft can then be identified using the identification signal.

US 2016/0173196 A1 describes a system and method for identifying a passive target, with a transmitting source comprising a laser and a receiving unit for detecting a laser beam reflected at the target. At least one retroreflector with a wave plate is used as an identification filter. Using a polarization modulator, pulse sequences with different polarizations can be generated, wherein the polarization of the reflected pulse train is analyzed. The variety of variants of the identification pattern can be increased by emitting laser beams with different wavelengths and by attaching wavelength-sensitive retroreflectors.

It is desirable to provide a method for identifying an object, in particular a satellite in space, which is robust against air turbulence, angle-tolerant, inexpensive and resource-saving and which allows a large number of objects to be uniquely identified.

It is also desirable to specify a transceiver station for carrying out such a method.

It is also desirable to provide an identification means for carrying out such a method.

It is also desirable to provide a system for carrying out such a method.

It is also desirable to provide a computer program product for carrying out such a method.

According to an aspect of the invention, a method for identifying an object, in particular a satellite in space, is proposed, which comprises at least one transceiver station with a source for generating a pulse train of pulses of electromagnetic radiation and at least one identification means arranged on the object, wherein the source sends the pulses of the pulse train as a transmit signal in the direction of the object and an electromagnetic receive signal is radiated back from the at least one identification means of the object to the transceiver station in response to each transmit signal.

At least two polarization states of the receive signal are detected with at least two detectors, offset in time by the transit time of the receive signal from the object to the transceiver station, and an actual identification pattern of the object is formed by aggregating the detected intensities of the polarization states of several successive receive signals, wherein in addition to the polarization states also a time shift of the individual receive signals relative to a trigger signal synchronized with the pulse train of the source is detected and the identification pattern is expanded to include the information about the time shift of the receive signal.

According to a favorable embodiment of the method, the pulses of the pulse train generated by the source can be converted into a multiple pulse, but at least a double pulse with different polarization states. Various methods for generating multiple pulses are described below.

It can then be advantageous if the time shift of the individual pulses of the multiple pulse can be determined relative to a trigger signal synchronized with the pulse train of the source. Each individual pulse from the multiple pulse forms a receive signal.

This ensures that the time for detecting a complete identification pattern is as short as possible. The influence of any turbulence between the transceiver station and the object that disrupts the identification pattern can thus be minimized.

The trigger signal is expediently generated by the pulse train of the source. For example, via a photodiode that detects part of the pulse train. For example, such a photodiode can be arranged behind a partially transparent mirror.

It is advantageous if the actual identification pattern is accumulated over several pulses of the pulse train emitted by the source and, if necessary, averaged.

The object is then expediently identified by comparing the actual identification pattern with a target identification pattern. On the other hand, the data forming the actual identification pattern can also be evaluated and compared with target parameters as a single parameter (such as the angle of the main axis of the polarization ellipsoid resulting at two polarization states).

The source for generating pulses in a pulse train can expediently comprise an ultra short pulse laser. The advantage of using laser radiation compared to radiation from radio transmitters is that laser radiation can be bundled much better and can therefore be focused into a small solid angle.

At large distances to objects, such as satellites in space, significantly greater signal strengths and thus system ranges can be achieved. Furthermore, interference can occur when using radio stations, which is why only limited radio licenses (each for a specific frequency) can be granted. Since the laser radiation is directional, there are no problems due to interference and no licensing is currently necessary.

As an identification means, it can be advantageous to use a retroreflector, triple mirror or triple prism, in order to reflect the light emitted by the source back to its source in an anti-parallel manner.

The reflected receive signal can be detected in a time-resolved manner using a telescope and a detector and using a time measuring device that is synchronized with the source, the distance of the retroreflector, and thus of the object, from the source can be calculated from the transit time of the signal from the source to the detector.

Furthermore, using this or another time measuring unit synchronized with the source, the time shift of the individual receive signals of a multiple pulse relative to one another or in comparison to the transit time of a single pulse can be detected. This time shift is used to be able to clearly assign the receive signal within the identification pattern.

According to the invention, the object is equipped with at least one passive optical assembly as an identification means, which has at least one retroreflector and other passive optical components, for example polarization optics such as polarizers, wave plates or wavelength-dependent transmission filters.

Through this assembly, properties of the transmit signal reflected as a receive signal, namely a combination of wavelength-dependent transmission, polarization and time course of the reflected intensity, of an incoming transmit signal that is also modulated in these properties, are changed in such a way that the object, in particular the satellites, can be uniquely identified by measurement of these properties in the reflected receive signal.

The receive signal is sent back from this optical assembly in the direction of the source, only limited by the diffraction of the transmitted signal. This increases the range and signal strength of the transmit signal and thus also the receive signal.

A purely passive optical method is thus advantageously proposed, which does not require any electrical power supply from the satellite. There is also no need for complex circuit electronics that are prone to failure, as the electronics on the satellite are inevitably exposed to ionizing space radiation.

The at least one identification means of the object can advantageously comprise a retroreflector assembly with a retroreflector and a first optical element, in particular a λ/4 wave plate, and a second optical element, in particular a wire grid polarizer or a λ/4 wave plate, wherein an optical axis of the second optical element is rotated by an angle relative to an optical axis of the first optical element. As a result, the polarization state of the receive signal can be changed in a suitable manner, so that the identification means and thus the object can be identified based on the receive signal.

According to the method according to the invention, this can optionally be carried out with different wavelengths of the transmit signal in order to increase the number of combinations or identification patterns by the different wavelengths. Wavelength-sensitive elements are arranged in the identification means.

According to a favorable embodiment of the method, at least two mutually spaced identification means can be arranged on the object and, due to a transit time difference of the reflected signal, receive signals that are separated in time can be radiated back from each identification means to the transceiver station as a multiple pulse in response to each transmit signal. This solution provides a way to convert the pulses generated by the source into multiple pulses.

The at least two mutually spaced identification means can, for example, be mounted at a distance as two or more purely passive optical assemblies, for example as a combination of retroreflectors, optical filters, polarization optics, on the object to be detected, for example a satellite. The distance is expediently so large that the receive signal reflected back by both identification means can be detected individually with a high degree of probability due to the difference in transit time of the pulses.

The probability of selective detection of the receive signals results from the typically expected difference in transit time between the identification means. This difference in transit time depends on the angle of the transceiver unit to the object and can vary depending on the rotation and position of the object.

According to a favorable embodiment of the method, the source can have a laser. In particular, the source can have a pulsed laser that emits laser pulses with a pulse length of at most 1 nanosecond and a pulse repetition rate of at least 100 pulses per second.

According to a favorable embodiment of the method, laser pulses can be emitted with a pulse duration that is small compared to the maximum transit time difference of the light reflected by the at least two identification means.

For the application described, the laser can emit short laser pulses, for example picosecond pulses, in order to be able to temporally resolve the signal from various retroreflector assemblies mounted on the satellite.

In addition, a high repetition rate and a low beam divergence of the laser are advantageous in order to be able to accumulate the detected identification patterns in a short time and thus increase the number of detected photons reflected back by the retroreflector.

According to a favorable embodiment of the method, the transceiver station can comprise a polarization state generator, which is designed in such a way that each pulse of the pulse train generated by the source is converted into a multiple pulse and each individual pulse from the multiple pulse can be emitted as a transmit signal with a respectively different transmit signal polarization state.

This type of conversion of pulses generated by the source into multiple pulses can be combined with the aforementioned system of using multiple identification means on the object. The number of pulses within the multiple pulse of the receive signal then results from the number of pulses within the transmit signal multiple pulse, multiplied by the number of identification means.

The transmit signals emitted as multiple pulses with different polarization states can then expediently be transmitted as exactly two transmit signals, wherein the one transmit signal then has a right circular polarization state (RC) and the other transmit signal has a left circular polarization state (LC).

This allows the polarization state of the individual pulses of the transmit signal to be changed using suitable optical assemblies such as λ/4 wave plates or wire grid polarizers in order to be able to identify the identification means with which the signals interacted.

According to a favorable embodiment of the method, the multiple pulses with different polarization states can be emitted at a distance that is large in comparison to the distance of the multiple pulses that are reflected back by the at least two identification means in response to each transmit signal.

Conveniently, the distance between the multiple pulses emitted as transmit signals can then be adapted to the distance between the multiple pulses reflected back from the at least two identification means in such a way that the multiple pulses reflected back from the at least two identification means can just be resolved.

According to a favorable embodiment of the method, an actual identification pattern of the object can be generated by combining the intensities I₁, I₂, I₃, I₄ detected when determining the polarization of at least two multiple pulses reflected back from the identification means that are offset in time due to the transmit signal multiple pulses.

Due to the large distance between a satellite and a ground station as a transceiver station, it is possible that not the entire reflected intensity of the transmitted signal is detected as a receive signal, but only a part of the diffraction pattern of the laser radiation reflected by the retroreflector. This also makes it possible to advantageously determine intensities of the receive signal in a suitable manner, which can be used to identify the object. Instead of a stationary transceiver station, a transportable transceiver station can be provided on a ship, an airplane or the like.

As described, the method according to the invention can advantageously be used to identify a satellite in space, wherein the identification means are arranged on the satellite and the transceiver station is located on the earth's surface. However, it is also possible for the method to be used, for example, to identify aircraft or ground vehicles or ships, wherein the transceiver station in these areas of application can also be located on the ground or on an aircraft or satellite.

According to a favorable embodiment of the method, the intensity of the receive signal can be detected depending on a transit time between sending out the transmitted signal and receiving the receive signal and/or depending on a wavelength of the receive signal.

According to a favorable embodiment of the method, the transmit signal can be transmitted in at least two different transmission phases with different wavelengths. For example, a laser with two different wavelengths can be used as a source, which laser sends transmit signals of different wavelengths at different transmission phases.

Alternatively, two lasers with different wavelengths can be used, each emitting pulses with a time shift. This allows the receive signals to be assigned to the different transmission phases and the respective transit times to be determined.

For this purpose, the at least one identification means can have at least one spectral filter with which a transmission beam with at least one wavelength can be filtered out. In this way, transmission beams with several wavelengths can be assigned to different identification means.

According to a favorable embodiment of the method, symmetry parameters can be determined from the measured intensities of the receive signal to determine the actual identification pattern. The symmetry parameters can serve to create dimensionless and standardized quantities for evaluating the intensities of the receive signal. This makes it possible to define identification patterns in a suitable manner, by means of which the object can be identified.

According to a further aspect of the invention, a transceiver station for identifying an object, in particular a satellite in space, is proposed, with at least one source of electromagnetic radiation for emitting a pulsed transmit signal as a pulse train to the object and with a telescope for receiving receive signals reflected back from the object, wherein the receiving station comprising a polarization state analyzer for determining the receive signal polarization states of the receive signals reflected back from the object. The polarization state analyzer comprises a time measuring unit to detect the polarization and the time shift of the pulses of a multiple pulse at a reference time synchronized with the source pulse train.

The transceiver station set up as a ground station has, for example, a laser as a source which emits laser light parallel to the optical axis of a telescope. For the application described, the laser should emit short laser pulses, (picosecond pulses), in order to be able to temporally resolve the signal from different retroreflector assemblies mounted on the satellite. In addition, a high repetition rate and low beam divergence of the laser are advantageous in order to be able to detect many photons reflected back by the retroreflector within a short time.

It is expedient if the source has a laser that is designed to emit laser pulses with a pulse length of at most 1 nanosecond and a pulse repetition rate of at least 100 pulses per second.

At the transceiver station, the back-reflected light is collected with a telescope, bundled and sent via the polarization state analyzer (PSA), depending on the polarization state, to at least two detectors, for example a respective single photon detector.

The detector can thus register the receive signal with high sensitivity.

The polarization state can expediently comprise a time measuring unit that is synchronized with the pulse train of the source. With the help of the time measuring unit, time shifts of the individual multiple pulses relative to a reference time can be measured.

It is expedient if fast photodiodes or photo-multipliers are used as detectors with evaluation electronics that can resolve time ranges in the sub-nanosecond range or picosecond range. In this way, the polarization of the multiple pulses within the pulse train generated by the source can be detected in time.

It is particularly advantageous if the polarization state analyzer can completely detect the polarization of the multiple pulse for each pulse emitted by the source.

For this purpose, it is particularly advantageous if the polarization state analyzer spatially separates the receive signal depending on the polarization state and a detector for receiving the receive signal is provided for each polarization state. In particular, each detector can be designed as a single photon detector.

For example, spatial separation can be achieved using beam splitters with polarization filters or, even better, polarization cubes.

According to a favorable embodiment of the transceiver station, the polarization state analyzer can comprise at least one beam splitter with a polarization filter and at least two fast photodetectors.

According to a favorable embodiment of the transceiver station, a time measuring unit can be present for detecting a transit time between sending out the transmit signal and receiving the receive signal. The transit time of the photon, measured between a photodiode at the output of the laser and the detector on the telescope, can be assigned to each detected photon using the time measuring unit.

According to a favorable embodiment of the transceiver station, the source can have a laser which is designed to emit laser pulses with a pulse length of at most 1 nanosecond and a pulse repetition rate of at least 100 pulses per second.

According to a favorable embodiment of the transceiver station, the polarization state generator can be designed to divide each transmit signal of the pulse train into multiple pulses with different polarization states.

Such a polarization state generator can expediently comprise at least one beam splitter, in particular at least two beam splitters, a wave plate and a delay path.

It is advantageous if the delay path is designed in such a way that the pulse spacing of the multiple pulse generated using the polarization state generator is greater than the maximum transit time difference of the light reflected back by several identification means arranged on the object.

According to a favorable embodiment of the transceiver station, the polarization state generator can be designed to set the polarization state of a pulse of the multiple pulse as right circularly polarized (RC) and the polarization state of another pulse of the multiple pulse as left circularly polarized (LC).

The circularly polarized laser beam then hits the satellite and is reflected back to the transceiver station as a receive signal by one or more retroreflector assemblies.

This allows the polarization state of the individual pulses of the transmit signal to be changed using suitable optical assemblies such as λ/4 wave plates or wire grid polarizers in order to be able to identify the identification means with which the signals interacted.

According to a favorable embodiment of the transceiver station, the source can be designed to emit a transmit signal with at least two different wavelengths. In particular, the source can have at least two lasers with different wavelengths. For example, a laser with two different wavelengths can be used as a source, which laser sends transmit signals of different wavelengths at different transmission phases. Alternatively, two lasers with different wavelengths can also be used, each emitting pulses with a time offset. This allows the receive signals to be assigned to the different transmission phases and the respective transit times to be determined.

According to a further aspect of the invention, an identification means for identifying an object, in particular a satellite in space, is proposed, at least comprising at least one retroreflector assembly, which retroreflector assembly is designed, to set a receive signal polarization state and/or a wavelength of a receive signal in response to a received transmit signal and to send the receive signal back as a signal anti-parallel to the transmit signal.

According to the invention, the object is equipped with at least one passive optical assembly as an identification means, which has at least one retroreflector and other passive optical components, for example polarization optics such as polarizers, wave plates or wavelength-dependent transmission filters.

Through this assembly, properties of the transmit signal reflected as a receive signal, namely a combination of wavelength-dependent transmission, polarization and time course of the reflected intensity, of an incoming transmit signal that is also modulated in these properties, are changed in such a way that the satellites can be uniquely identified by measurement of these properties in the reflected receive signal. The transmit signal can conveniently be a pulsed laser beam.

According to a favorable embodiment of the identification means, the retroreflector assembly can have a retroreflector and a first optical element, in particular a λ/4 wave plate, arranged first in a direction of incidence of the transmit signal, as well as a second optical element arranged behind the first optical element in the direction of incidence, in particular a wire grid polarizer or a λ/4 wave plate. An optical axis of the second optical element can be rotated by an angle relative to an optical axis of the first optical element, whereby the receive signal polarization state of the receive signal can be adjusted.

The retroreflector assembly conveniently consists of or comprises a metal-coated retroreflector, an outer λ/4 wave plate and another optical element, a wire grid polarizer or another λ/4 wave plate, which is mounted between the outer wave plate and the retroreflector. The optical axis of the optical element is rotated at an angle relative to the optical axis of the outer λ/4 wave plate. By selecting the central optical component, wire grid polarizer or λ/4 wave plate, as well as the angle, various retroreflector assemblies can be produced, which can be identified polarimetrically using remote detection.

According to a favorable embodiment, the identification means can comprise at least one spectral filter with which a transmission beam with at least one wavelength can be filtered out. In this way, transmission beams with several wavelengths can be assigned to different identification means.

According to a further aspect of the invention, a system for identifying an object, in particular a satellite in space, is proposed using a method as described above, comprising at least one such transceiver station and at least one such identification means which is arranged on the object.

A purely passive optical method is advantageously proposed, which does not require any electrical power supply from the satellite. There is also no need for complex circuit electronics that are prone to failure, as the electronics on the satellite are inevitably exposed to ionizing space radiation.

According to a further aspect of the invention, a computer program product for identifying an object, in particular a satellite in space, is proposed with a system, which comprises at least one transceiver station with at least one source for generating a pulse train of pulses of electromagnetic radiation and at least one identification means arranged on the object, wherein the source sends the pulses of the pulse train as a transmit signal in the direction of the object and an electromagnetic receive signal is radiated back from the at least one identification means of the object to the transceiver station in response to each transmit signal. The computer program product comprises at least one computer-readable storage medium, which comprises program instructions that can be executed on a computer system and cause the computer system to carry out a method as described above.

At least two polarization states of the receive signal offset in time by the transit time of the received signal from the object to the transceiver station are detected with at least two detectors and an actual identification pattern of the object is formed by aggregating the detected intensities of the polarization states of several successive receive signals. In addition to the polarization states, a time shift of the individual receive signals relative to a trigger signal synchronized with the pulse train of the source is also detected and the identification pattern is expanded to include the information about the time shift of the receive signal.

The intensity of at least two polarization states of the receive signal is determined in a time-resolved manner with regard to the multiple pulses. An actual identification pattern of the object is formed by combining the detected intensities of the polarization state of the receive signal. The object is identified by comparing the actual identification pattern with a target identification pattern.

The computer program product comprises software code portions loadable directly into the memory of a digital computer with which the method is executed when the software code portions are executed by the computer.

The computer program product can be formed by a computer program or can comprise at least one additional component in addition to the computer program. The at least one additional component can be designed as hardware and/or as software.

An example of the at least one additional component that is designed as hardware is a storage medium that is readable by the digital computer and/or on which the software code portions are stored.

An example of the at least one additional component that is designed as software is a cloud application program, which is designed to distribute the software code portions to different processing units, in particular different computers, of a cloud computing system, wherein each of the processing units is configured for executing one or more software code portions.

In particular, the method as described above can be carried out with the software code portions if the software code portions are executed by the processing units of the cloud computing system.

According to a further aspect of the invention, a data processing system for executing a data processing program is proposed, which comprises computer-readable program instructions in order to carry out a method for identifying an object, in particular as described above.

### BRIEF DESCRIPTION OF THE DRAWINGS

Further advantages will be apparent from the following description of the drawings. Exemplary embodiments of the invention are shown in the figures. The figures, the description, and the claims contain numerous features in combination. A person skilled in the art will expediently also consider the features individually and combine them into further meaningful combinations.

FIG. 1 shows a schematic overview of a system for identifying an object, in particular a satellite in space, according to an exemplary embodiment of the invention;

FIG. 2 is a schematic representation of a transceiver station of the system according to FIG. 1;

FIG. 3 is a schematic representation of a system with two identification means for identifying an object, with a polarization state analyzer for simultaneously measuring different polarization states of the receive signal, and a polarization state generator for generating double pulses from each pulse of the pulse train emitted by the source;

FIG. 4 is a schematic representation of a retroreflector assembly of an identification means of the system according to FIG. 1;

FIG. 5 shows measured intensities of a receive signal for a system according to FIG. 3;

FIG. 6 shows calculated symmetry parameters for twelve different retroreflector assemblies with vertical incidence of the transmit signal;

FIG. 7 shows calculated symmetry parameters for twelve different retroreflector assemblies with vertical incidence of the transmit signal;

FIG. 8 shows measured symmetry parameters of a retroreflector assembly as a function of an angle of incidence of the transmit signal; and

FIG. 9 shows measured symmetry parameters of a further retroreflector assembly as a function of a rotation angle on the retroreflector assembly.

### DETAILED DESCRIPTION

In the figures, identical or identically acting components are identified by the same reference numerals. The figures only show examples and are not to be understood as restrictive.

Directional terminology used in the following with terms such as “left”, “right”, “above”, “below”, “in front of”, “behind”, “after”, and the like only serves for better comprehension of the figures and is in no way intended to restrict the generality. The components and elements shown, their configuration and use can vary according to the considerations of a person skilled in the art and can be adapted to the respective applications.

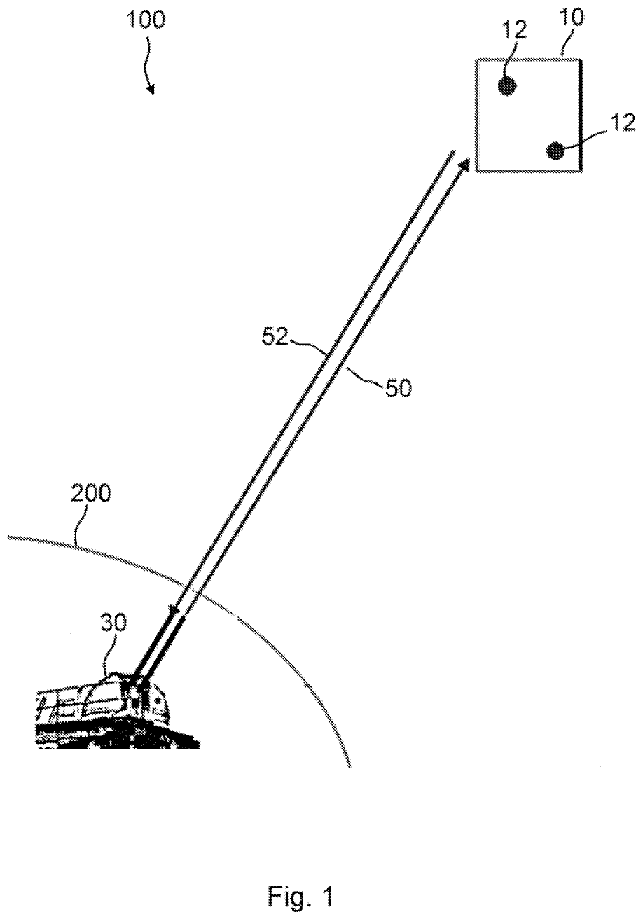

FIG. 1 shows a schematic overview of a system 100 for identifying an object 10, in particular a satellite 10 in space, according to an exemplary embodiment of the invention;

In this example, the system 100 comprises a transceiver station 30 arranged on the earth's surface 200, from which a transmit signal 50, for example a laser beam, is sent to a satellite 10 on which two identification means 12 are arranged.

A receive signal 52 is sent back from these identification means 12 and received and evaluated by the transceiver station 30. The identification means 12 are preferably passive optical assemblies with retroreflectors.

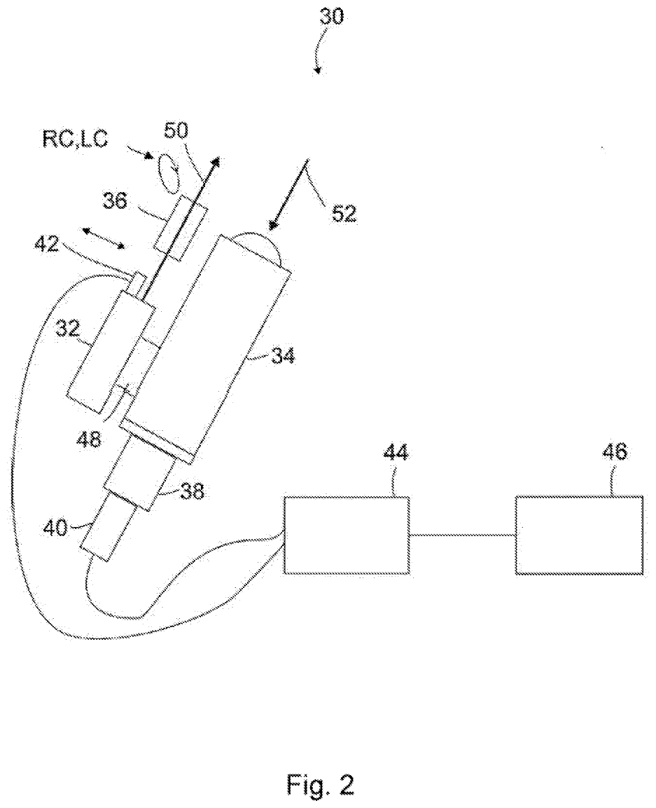

FIG. 2 shows a schematic representation of a transceiver station 30 of the system 100 according to FIG. 1.

The transceiver station 30 has a source 32 of electromagnetic radiation for sending a transmit signal 50 to the object 10 and a telescope 34 for receiving a receive signal 52 reflected back from the object 10. The source 32 emits a linearly polarized transmit signal 50. The source 32 can have a laser that is designed to emit laser pulses with a pulse length of at most 1 nanosecond and a pulse repetition rate of at least 100 pulses per second. The laser pulses emitted by the laser form a laser pulse train.

A partial intensity of the laser pulses is detected by a detector 42 to generate a trigger signal. The trigger signal is used to synchronize the time shift of the pulses from the receive signal 52 with the pulses emitted by the source.

The transmit signal 50 leaving the source 32 passes through a polarization state generator 36, which is provided to provide the transmit signal 50 with different transmit signal polarization states. The polarization state generator 36 generates a double pulse, wherein the first pulse of the double pulse is provided with a first transmit signal polarization state and the second pulse of the double pulse is provided with a second transmit signal polarization state.

The polarization state generator 36 is designed, for example, to set a right circularly polarized state as the first transmit signal polarization state RC of the transmit signal 50 and to set a left circularly polarized state as the second transmit signal polarization state LC.

The polarization state generator 36 can advantageously be designed in such a way as to divide each transmit signal 50 of the pulse train into multiple pulses with different polarization states. For this purpose, the polarization state generator 36 can, for example, comprise at least two beam splitters 70, 72, a wave plate and a delay path 71.

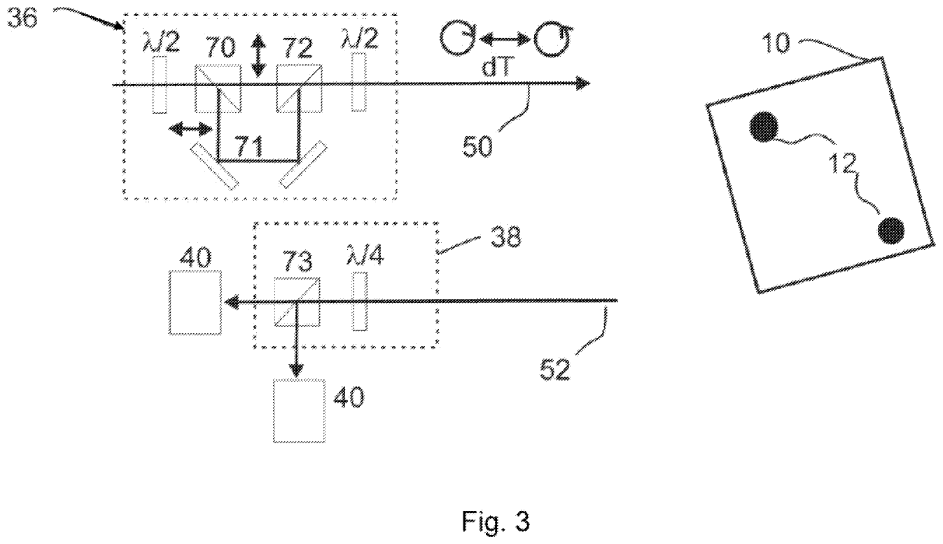

The polarization state generator 36 may comprise a polarization beam splitter 70 as shown in FIG. 3 for dividing the laser beam into two arms. A delay path 71 is provided in one arm in order to delay the two pulses divided by the beam splitter 70 relative to one another. The polarization state generator 36 comprises another polarization beam splitter 72 to reunite the two beam paths again.

Ideally, the delay path 71 is so long that the pulses have a transit time difference that is greater than the maximum provided by several identification means 12 arranged on the object 10.

At the output of the telescope 34, a polarization state analyzer 38 is provided in order to select a plurality of receive signal polarization states RC, LC of the receive signal 52 reflected back from the object 10 and to forward them to different detectors 40 in a spatially separated manner. Such a polarization state analyzer 38 is also shown in more detail in FIG. 3. The polarization state and the time information are transmitted to the evaluating computer 46 via a time measuring unit 44.

The detectors 40 are provided for receiving the receive signal 52 and can in particular be designed as a single photon detector.

The time measuring unit 44 is electrically connected to each detector 40 and is provided for detecting a transit time t of the transmit signal 50 between sending out the transmit signal 50 and receiving the receive signal 52. The transit time t of an incoming receive signal 52 is also transmitted to the computer 46.

The source 32 can be further designed to send out a transmit signal 50 with at least two different wavelengths in order to have further possible combinations for identifying the object 10, which can interact with the identification means 12 of the object 10 in a suitable manner. In particular, the source 32 can have at least two lasers 32 with different wavelengths. The identification of the object at at least two different wavelengths can also take place via several transceiver stations 30, the transmit signal 50 of which is generated with lasers 32 of different wavelengths. Furthermore, electromagnetic radiation with different wavelengths can be generated by using non-linear crystals (e.g. for frequency doubling).

The computer 46 may be part of a data processing system for executing a data processing program that includes computer-readable program instructions to perform a method for identifying the object 10. For this purpose, a computer program product can include at least one computer-readable storage medium, which comprises program instructions that can be executed on the computer 46 and cause the computer 46 to carry out the method.

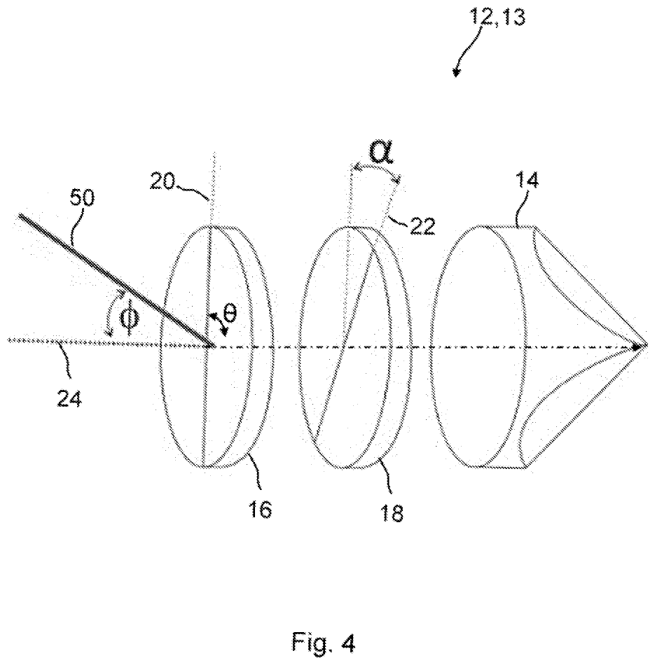

FIG. 4 is a schematic representation of a retroreflector assembly 13 of an identification means 12 of the system 100 according to FIG. 1;

The identification means 12 comprises a retroreflector assembly 13, which is designed to set a receive signal polarization state RC, LC of a receive signal 52 in response to a received transmit signal 50 and to send the receive signal 52 back anti-parallel to the transmit signal 50.

The retroreflector assembly 13 comprises a retroreflector 14, which is designed as a metal-coated triple prism. The retroreflector assembly 13 further comprises a first optical element 16 in the form of a λ/4 wave plate, which is arranged first in an incidence direction 24 of the transmit signal 50, and a second optical element 18 which is arranged behind the first optical element 16 in the incidence direction 24, in form of a wire grid polarizer or another λ/4 wave plate. For the λ/4 wave plates, a truly zero-order wave plate is advantageously used, which has a low dependence of the phase shift on the temperature and the angle of incidence.

The optical axis 22 of the second optical element 18 is rotated by an angle α relative to the optical axis 20 of the first optical element 16, whereby the receive signal polarization state RC, LC of the receive signal 52 can be adjusted.

The transmit signal 50 is incident at an angle of incidence φ and a rotation angle θ of the first optical element 16 against the direction of incidence 24 of the retroreflector assembly 13.

By selecting the central optical element 18 and the angle α of the second optical element 18, various retroreflector assemblies 13 can be realized, which can be identified by polarimetric analysis of the receive signal 52.

In an embodiment not shown, the identification means can comprise at least one spectral filter with which a transmission beam 50 with at least one wavelength can be filtered out. The retroreflector assembly 13 can thus set a wavelength of a receive signal 52 in response to a received transmit signal 50 and send the receive signal 52 back anti-parallel to the transmit signal 50.

The method according to the invention for identifying the object 10, in particular a satellite in space, with the system 100, which comprises the transceiver station 30 with the source 32 of electromagnetic radiation and at least one identification means 12 arranged on the object 10, has the following steps.

The source 32 uses a laser to generate a pulse train of electromagnetic radiation. Furthermore, the source 32 generates from each pulse within the pulse train a multiple pulse of several successive transmit signals with different transmit signal polarization states. For example, a pulse can be emitted with a first transmit signal polarization state RC and another pulse with a different transmit signal polarization state LC.

The source 32 sends the transmit signal 50 prepared as a multiple pulse with the electromagnetic radiation and different transmit signal polarization states within the multiple pulse in the direction of the object 10. An electromagnetic receive signal 52 is radiated back from the at least one identification means 12 of the object 10 in response to each of the transmit signals 50 within the multiple pulse and directed to the transceiver station 30.

The intensity of the polarization states I₁, I₂, I₃, I₄ of the receive signal 52 is each detected from at least a first receive signal polarization state RC, LC and at least a second, different receive signal polarization state RC, LC.

This detection of the intensities is expediently carried out by aggregating the number of measured photons over several pulses of a pulse train, wherein both the polarization state and the time shift of the receive signal 52 are determined in comparison to the transit time of a single pulse.

An actual identification pattern of the object 10 is formed by combining the detected intensities I₁, I₂, I₃, I₄ of the receive signal 52. The object 10 is identified by comparing the actual identification pattern with a target identification pattern. To determine the actual identification pattern, symmetry parameters can be determined from the measured intensities I₁, I₂, I₃, I₄ of the receive signal 52, as shown in FIGS. 4 to 8.

The intensity I₁, I₂, I₃, I₄ of the receive signal 52 is detected depending on a transit time t between sending the transmitted signal 50 and receiving the receive signal 52 and/or depending on a wavelength of the receive signal 52. This allows different identification means 12 to be distinguished on an object 10.

For this purpose, the transmit signal 50 can be transmitted in at least two different transmission phases with different wavelengths.

The source 32 can advantageously have a laser, which emits laser pulses with a pulse length of at most 1 nanosecond and a pulse repetition rate of at least 100 pulses per second, in particular for measuring the transit time t and for realizing different polarization states.

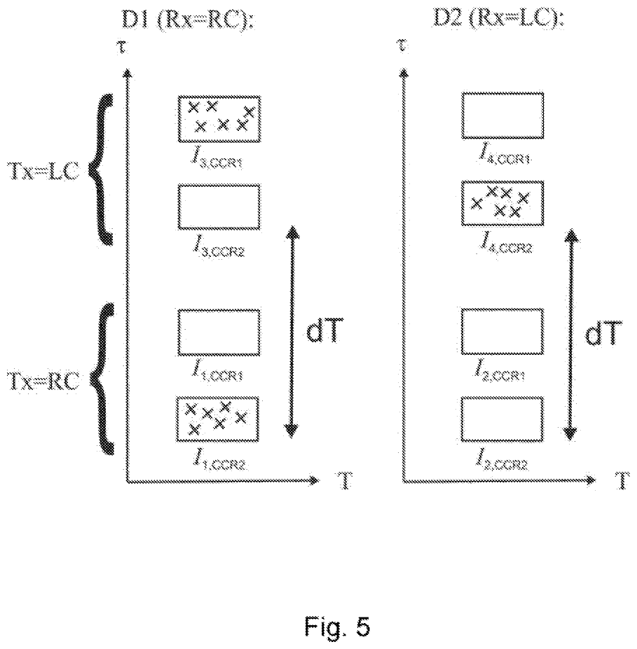

FIG. 5 shows measured intensities I₁, I₂, I₃, I₄ of a receive signal 52 from two different retroreflector assemblies 13 with the designations CCR1, CCR2 (CCR=corner cube reflector) for different receive signal polarization states RC, LC. The intensities I₁, I₂, I₃, I₄for each retroreflector CCR1, CCR2 result from the number of detected photons in the interval τ₁, τ₂, τ₃, τ₄ for the receive signal polarization states RC and LC measured using the two detectors 40 and aggregated over several pulses of the pulse train emitted by the source.

Photons and their transit time t are detected depending on the time of arrival and the detector in the polarization state analyzer 38. The two retroreflectors CCR1, CCR2 can be distinguished due to the different distance to the transceiver station 30 via the deviation Δt from the average transit time t. Therefore, each detected photon (in FIG. 5 as x symbols and deviations dT from the average transit time t) can be assigned to one of the two retroreflector assemblies CCR1, CCR2. For each detector there are four different measurement signals that are offset in time, since the two transmit signal polarization states that are offset in time are combined with the receive signals of the two retroreflectors that are offset in time.

For each retroreflector CCR1, CCR2, 4 intensities I₁, I₂, I₃, I₄ are measured:

$${I}_{1} = I ( Tx = RC , Rx = RC )$$

$${I}_{2} = I ( Tx = RC , Rx = LC )$$

$${I}_{3} = I ( Tx = LC , Rx = RC )$$

$${I}_{4} = I ( Tx = LC , Rx = LC )$$

As can be seen in FIG. 5, only intensity I₃ was used for the first retroreflector assembly CCR1, namely for the emission of left-hand circularly polarized light (Tx=LC) and detection of right-hand circularly polarized light (Rx=RC), measured on a detector 40 designated D1 in the figure. For the retroreflector assembly CCR2, identical intensities I₁ (Tx=RC and Rx=RC) and I₄ (Tx=LC and Rx=LC) were respectively measured at one detector 40, designated D1 in the figure, and at the other detector 40, designated D2.

Using the definitions Iₐ=I₁+I₂ and I_{b}=I₃+I₄ from these intensities I₁, I₂, I₃, I₄ the following symmetry parameters P₁, P₂, P₃ can be derived:

$${P}_{1} = \frac{{I}_{a} - {I}_{b}}{{I}_{a} + {I}_{b}} , {P}_{2} = \frac{{I}_{1} - {I}_{2}}{{I}_{1} + {I}_{2}} , {P}_{3} = \frac{{I}_{3} - {I}_{4}}{{I}_{3} + {I}_{4}} ,$$

each of which has a value range from 1 to −1.

The symmetry parameters P₁, P₂, P₃ of the retroreflector assembly 13 described in FIG. 4 can be calculated for different angles α and depending on whether a wire grid polarizer or a λ/4 wave plate is mounted in the assembly. This can be done, for example, using the Müller-Matrix arithmetic according to Russell A. Chipman, “Handbook of Optics, Chapter 22: Polarimetry, Optical Society of America, McGraw-Hill, New York, 1995, and is described in the following example.

The Müller-Matrix of a wave plate (“Linear Retarder”) M_{LR}(θ, δ) with a fast axis along θ and the phase shift δ(e.g. 90° for a λ/4 wave plate) is given by:

$${M}_{LR} ( θ , δ ) = [ \begin{matrix}1 & 0 & 0 & 0 \\ 0 & {cos}^{2} ( 2 θ ) + {sin}^{2} ( 2 θ ) cos δ & sin ( 2 θ ) cos ( 2 θ ) ( 1 - cos δ ) & - sin ( 2 θ ) sin δ \\ 0 & sin ( 2 θ ) cos ( 2 θ ) ( 1 - cos δ ) & {sin}^{2} ( 2 θ ) {cos}^{2} ( 2 θ ) cos δ & cos ( 2 θ ) sin δ \\ 0 & - sin ( 2 θ ) sin δ & - cos ( 2 θ ) sin δ & cos δ\end{matrix} ]$$

The Müller matrix of a polarizer Mₚ(θ) with the polarization axis along θ is:

$${M}_{P} ( θ ) = 0.5 [ \begin{matrix}1 & cos ( 2 θ ) & sin ( 2 θ ) & 0 \\ cos ( 2 θ ) & {cos}^{2} ( 2 θ ) & sin ( 2 ) cos ( 2 θ ) & 0 \\ sin ( 2 θ ) & sin ( 2 θ ) cos ( 2 θ ) & {sin}^{2} ( 2 θ ) & 0 \\ 0 & 0 & 0 & 0\end{matrix} ]$$

For retroreflectors with metal back coating and small angles of incidence φ, the Müller matrix is approximately that of an ideal mirror:

$${M}_{CCR} = [ \begin{matrix}1 & 0 & 0 & 0 \\ 0 & 1 & 0 & 0 \\ 0 & 0 & - 1 & 0 \\ 0 & 0 & 0 & - 1\end{matrix} ]$$

The Müller matrices of the retroreflector assemblies M_{WP} (with second wave plate) and Mₚ (with polarizer) thus result in:

$${M}_{CCR , WP} ( θ , α ) = {M}_{LR} ( - θ , 90 ° ) {M}_{LR} ( - ( θ + α ) , 90 ° ) {M}_{CCR} {M}_{LR} ( ( θ + α ) , 90 ° ) {M}_{LR} ( θ , 90 ° )$$

$${M}_{CCR , P} ( θ , α ) = {M}_{LR} ( - θ , 90 ° ) {M}_{P} ( - ( θ + α ) ) {M}_{CCR} {M}_{P} ( θ + α ) {M}_{LR} ( θ , 90 ° )$$

This takes into account that the polarizer and the wave plate mounted directly on the retroreflector are rotated by the angle α of the first wave plate. In addition, an angle of θ on the light's path to the retroreflector corresponds to an angle of −θ on the return path, since the optical component is transmitted in the opposite direction.

For the intensities I₁ and I₂, right circularly polarized light with the Stokes vector (1,0,0,1)^{τ} is emitted from the transceiver station, wherein the symbol T stands for the transpose of the vector. For the intensities I₃ and I₄, left circularly polarized light with the Stokes vector (1,0,0,−1)^{τ} is emitted. After reflection by the retroreflector assembly, the light in the polarization state analyzer 38 passes through a λ/4 plate and a polarizer. The measured intensities are then the first element \hat{n}₁ of the Stokes vector for the entire system.

$${I}_{1} = {M}_{P} ( 0 ° ) {M}_{LR} ( + 45 ° , 90 ° ) {M}_{CCR , WP / P} ( θ , α ) {( 1 , 0 , 0 , 1 )}^{τ} {\hat{n}}_{1}$$

$${I}_{2} = {M}_{P} ( 0 ° ) {M}_{LR} ( - 45 ° , 90 ° ) {M}_{CCR , WP / P} ( θ , α ) {( 1 , 0 , 0 , 1 )}^{τ} {\hat{n}}_{1}$$

$${I}_{3} = {M}_{P} ( 0 ° ) {M}_{LR} ( + 45 ° , 90 ° ) {M}_{CCR , WP / P} ( θ , α ) {( 1 , 0 , 0 , - 1 )}^{τ} {\hat{n}}_{1}$$

$${I}_{4} = {M}_{P} ( 0 ° ) {M}_{LR} ( - 45 ° , 90 ° ) {M}_{CCR , WP / P} ( θ , α ) {( 1 , 0 , 0 , - 1 )}^{τ} {\hat{n}}_{1}$$

This results in the symmetry parameters:
Assemblies with second wave plate: P₁=0,P₂=−P₃=cos (4α)
Assemblies with polarizer: P₁=sin (2α), P₂=P₃=−sin (2α).

The following table lists calculated symmetry parameters P₁, P₂, P₃ of 12 different retroreflector assemblies No. 1 to No. 12 at vertical incidence φ=0° of the laser radiation. The angles α were chosen so that the values of the symmetry parameters P₁, P₂, P₃ are as far apart as possible in order to be able to distinguish the assemblies as easily as possible (also taking measurement errors into account).

| Assembly | | Optical element in front of the | | | |
|---|---|---|---|---|---|
| no. | α | retroreflector | P₁ | P₂ | P₃ |
| 1 | 0° | λ/4 wave plate | 0 | 1 | −1 |
| 2 | 12° | λ/4 wave plate | 0 | 0.67 | −0.67 |
| 3 | 18° | λ/4 wave plate | 0 | 0.31 | −0.31 |
| 4 | 26.5° | λ/4 wave plate | 0 | −0.28 | 0.28 |
| 5 | 33° | λ/4 wave plate | 0 | −0.67 | 0.67 |
| 6 | 45° | λ/4 wave plate | 0 | −1 | 1 |
| 7 | −45° | wire grid polarizer | −1 | 1 | 1 |
| 8 | −20° | wire grid polarizer | −0.64 | 0.64 | 0.64 |
| 9 | −10° | wire grid polarizer | −0.34 | 0.34 | 0.34 |
| 10 | 10° | wire grid polarizer | 0.34 | −0.34 | −0.34 |
| 11 | 20° | wire grid polarizer | 0.64 | −0.64 | −0.64 |
| 12 | 45° | wire grid polarizer | 1 | −1 | −1 |

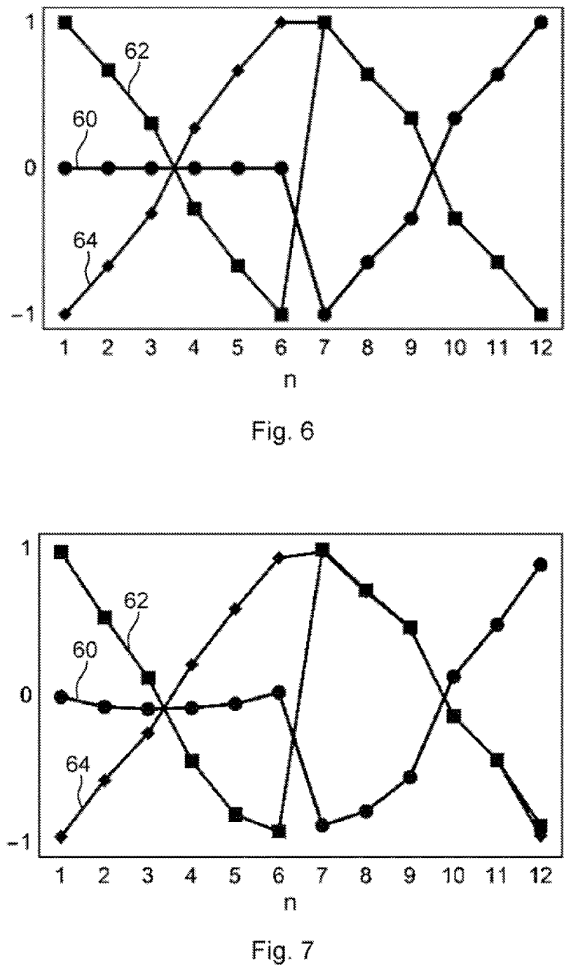

FIG. 6 shows the calculated symmetry parameters P₁, P₂, P₃ (with the reference numerals 60 for the symmetry parameter P₁, 62 for the symmetry parameter P₂, 64 for the symmetry parameter P₃) from the table for the twelve different retroreflector assemblies (n=1 to 12) plotted against each other at vertical incidence φ=0° of the transmit signal 50. The 12 different retroreflector assemblies can be clearly identified based on the values for the symmetry parameters P₁, P₂, P₃.

FIG. 7 shows symmetry parameters P₁, P₂, P₃ measured with a test arrangement (with the reference numerals 60 for the symmetry parameter P₁, 62 for the symmetry parameter P₂, 64 for the symmetry parameter P₃) for twelve different retroreflector assemblies with the parameters given in the table for the angle α and the optical element in front of the retroreflector, also at vertical incidence φ=0° of the transmit signal 50, plotted against each other. The measured values of the symmetry parameters P₁, P₂, P₃ obviously agree well with the calculated values. This makes it possible to identify the 12 different retroreflector assemblies n=1 to 12 with sufficient accuracy based on the values for the symmetry parameters P₁, P₂, P₃.

In addition, the angle dependence of the symmetry parameters was measured, both in relation to the angle of incidence φ and the rotation θ for selected retroreflector assemblies. This is significant because the orientation of the object, particularly the satellite, is generally not known during identification.

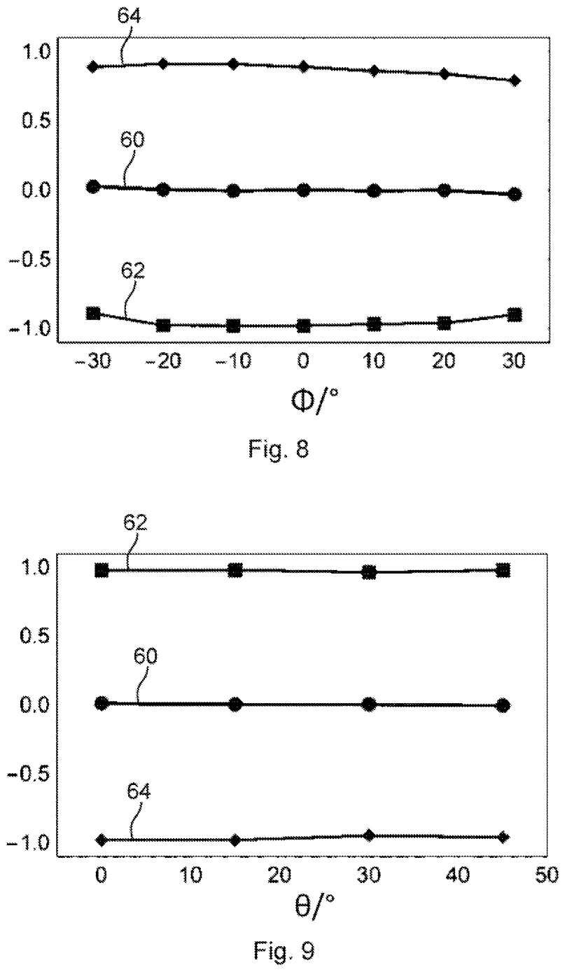

FIG. 8 shows measured symmetry parameters P₁, P₂, P₃ (with reference numerals 60 for the symmetry parameter P₁, 62 for the symmetry parameter P₂, 64 for the symmetry parameter P₃) of the individual retroreflector assembly n=6 plotted as a function of angle of incidence φ of the transmit signal 50. This results in a variation of the symmetry parameters P₁, P₂, P₃ that is largely independent of the angle of incidence φ.

In FIG. 9, measured symmetry parameters P₁, P₂, P₃ of the further individual retroreflector assembly n=1 are plotted as a function of the rotation angle θ on the retroreflector assembly. Here too, there is a course of the symmetry parameters P₁, P₂, P₃ that is largely independent of the rotation angle θ.

The angle-independent curves of the symmetry parameters P₁, P₂, P₃ show that the symmetry parameters P₁, P₂, P₃ represent robust parameters for identifying objects using the method according to the invention.

By means of the symmetry parameters P₁, P₂, P₃ determined from the intensity measurements, actual identification patterns can be created, which enable identification of unknown objects, in particular satellites in space, by comparison with stored target identification patterns, which can be determined in advance by calculation.

The number of distinguishable objects depends on the number n of distinguishable retroreflector assemblies (e.g. n=12 for 12 different assemblies) and the number k of assemblies that are mounted on the object and can be distinguished over transit time. The number of combinations can be calculated using the binomial coefficient

$$( \begin{matrix}n + k - 1 \\ k\end{matrix} ) .$$

There are 78 combinations for two assemblies mounted on the object. If one or two assemblies are mounted, this results in 78+12=90 combinations. For up to three assemblies there are 364+78+12=454 combinations. In order to further increase the number of combinations, the method according to the invention can also be extended to several wavelengths. The number of retroreflector assemblies can then be increased using spectral filters. At two wavelengths, up to four retroreflector assemblies would be sufficient to make 20,474 satellites identifiable.

### LIST OF REFERENCE NUMERALS

10 object
12 identification means
13 retroreflector assembly
14 retroreflector
16 first optical element
18 second optical element
20 optical axis
22 optical axis
24 direction of incidence
30 transceiver station
32 source
34 telescope
36 polarization state generator
38 polarization State Analyzer
40 detector
42 photodiode for trigger signal
44 time measurement unit
46 computer
48 mount
50 transmit signal
52 receive signal
60 symmetry parameter P₁
62 symmetry parameter P₂
64 symmetry parameter P₃
70 polarization beam splitter (PBS)
71 delay path
72 polarization beam splitter (PBS)
73 polarization beam splitter
100 system
200 earth surface

1. A method for identifying an object, with a system which has at least one transceiver station with a source for generation of a pulse train of pulses of electromagnetic radiation and at least one identification means arranged on the object, wherein the source sends the pulses of the pulse train as a transmit signal in the direction of the object and from the at least one identification means of the object, an electromagnetic receive signal is radiated back to the transceiver station in response to each transmit signal, wherein at least two polarization states of the receive signal are detected with a time offset equal to the transit time of the receive signal from the object to the transceiver station with at least two detectors and an actual identification pattern of the object is formed by aggregation of the detected intensities of the polarization states of several successive receive signals, wherein, in addition to the polarization states, a time shift of the individual receive signals relative to a trigger signal synchronized with the pulse train of the source is also detected and the identification pattern is expanded by the information about the time shift of the receive signal.

2. The method according to claim 1, wherein the pulses of the pulse train generated by the source are converted into a multiple pulse, but at least a double pulse with different polarization states, in particular wherein the time shift of the individual pulses from the multiple pulse relative to a trigger signal synchronized with the pulse train of source is determined.

3. The method according to claim 1, wherein at least two mutually spaced identification means are arranged on the object and, due to a transit time difference of the reflected transmit signal from each identification means, temporally separated receive signals are reflected back as a multiple pulse in response to each transmit signal to the transceiver station and thus the pulses generated by the source are converted into multiple pulses.

4. The method according to claim 1, wherein laser pulses are emitted with a pulse duration that is small compared to the maximum transit time difference of the reflected transmit signal due to the arrangement of the at least two identification means.

5. The method according to claim 1, wherein the transceiver station comprises a polarization state generator, which is designed so that each pulse of the pulse train generated by the source is converted into a multiple pulse and each individual pulse from the multiple pulse is emitted as a transmit signal with a respective different transmit signal polarization state.

6. The method according to claim 5, wherein exactly two transmit signals are transmitted, and one of the transmit signals has the polarization state RC and the other transmit signal has the polarization state LC.

7. The method according to claim 3, wherein the transceiver station comprises a polarization state generator, which is designed so that each pulse of the pulse train generated by the source is converted into a multiple pulse and each individual pulse from the multiple pulse is emitted as a transmit signal with a respective different transmit signal polarization state, and wherein the transmit signal multiple pulses with different polarization states are emitted with a spacing that is large compared to the spacing of the receive signal multiple pulses which are reflected back in response to each transmit signal by the at least two identification means.

8. The method according to claim 7, wherein the distance between the multiple pulses emitted as transmit signals is adapted to the distance between the receive signal multiple pulses reflected back from the at least two identification means in such a way that the multiple pulses reflected back from the at least two identification means can just be resolved.

9. A transceiver station for identifying an object, in particular a satellite in space, with at least one source of electromagnetic radiation for emitting a pulsed transmit signal as a pulse train to the object and with a telescope for receiving receive signals reflected back from the object, wherein the receiving station comprises a polarization state analyzer for determination of the receive signal polarization states of the receive signals reflected back from the object, wherein the polarization state analyzer comprises a time measuring unit in order to detect the polarization and the time shift of the pulses of a multiple pulse at a reference time synchronized with the pulse train of the source.

10. The transceiver station according to claim 9, wherein the polarization state analyzer comprises at least one beam splitter with a polarization filter and at least two fast photodetectors.

11. The transceiver station according to claim 9, wherein a time measuring unit is present for detection of a transit time between sending out the transmit signal and receiving the receive signal.

12. The transceiver station according to claim 9, wherein the source has a laser which is designed to emit laser pulses with a pulse length of at most 1 nanosecond and a pulse repetition rate of at least 100 pulses per second.

13. The transceiver station according to claim 9, wherein there is a polarization state generator which is designed to divide each transmit signal of the pulse train into multiple pulses with different polarization states.

14. The transceiver station according to claim 13, wherein the polarization state generator comprises at least two beam splitters, a wave plate and a delay path.

15. The transceiver station according to claim 13, wherein the polarization state generator is designed to set the polarization state of a pulse of the multiple pulse as right circularly polarized and the polarization state of another pulse of the multiple pulse as left circularly polarized.

16. An identification arrangement for identifying an object, the identification arrangement comprising at least one retroreflector assembly, which is designed as a retroreflector assembly, to set a receive signal polarization state and/or a wavelength of a receive signal in response to a received transmit signal and to send the receive signal back as a signal anti-parallel to the transmit signal.

17. The identification arrangement according to claim 16, wherein the retroreflector assembly has a retroreflector and a first optical element 16), in particular a λ/4 wave plate, arranged first in an incidence direction of the transmit signal, and a second optical element, in particular a wire grid polarizer or a λ/4 wave plate, arranged behind the first optical element in the direction of incidence, wherein an optical axis of the second optical element is rotated by an angle relative to an optical axis of the first optical element, whereby the receive signal polarization state of the receive signal can be adjusted.

18. A system for identifying an object with a method according to claim 1,
the system comprising
at least one transceiver station for identifying the object, in particular a satellite in space, with at least one source of electromagnetic radiation for emitting a pulsed transmit signal as a pulse train to the object and with a telescope for receiving receive signals reflected back from the object, wherein the receiving station comprises a polarization state analyzer for determination of the receive signal polarization states of the receive signals reflected back from the object, wherein the polarization state analyzer comprises a time measuring unit in order to detect the polarization and the time shift of the pulses of a multiple pulse at a reference time synchronized with the pulse train of the source and
at least one identification arrangement for identifying the object, which is arranged on the object, the at least one identification arrangement comprising at least one retroreflector assembly, which is designed as a retroreflector assembly, to set a receive signal polarization state and/or a wavelength of a receive signal in response to a received transmit signal and to send the receive signal back as a signal anti-parallel to the transmit signal.

19. A computer program product for identifying an object with a system, which comprises at least one transceiver station with at least one source for generation of a pulse train of pulses of electromagnetic radiation and at least one identification arrangement arranged on the object, wherein the source sends the pulses of the pulse train as a transmit signal in the direction of the object and an electromagnetic receive signal is radiated back from the at least one identification arrangement of the object to the transceiver station in response to each transmit signal,
wherein the computer program product comprises at least one computer-readable storage medium which comprises program instructions that can be executed on a computer system and cause the computer system to carry out a method according to claim 1,
wherein at least two polarization states of the receive signal offset in time by the transit time of the receive signal from the object to the transceiver station are detected with at least two detectors and an actual identification pattern of the object is formed by aggregating the detected intensities of the polarization states of several successive receive signals, and
wherein, in addition to the polarization states, a time shift of the individual receive signals relative to a trigger signal synchronized with the pulse train of the source is also detected and the identification pattern is expanded to include the information about the time shift of the receive signal.

20. A data processing system for execution of a data processing program which comprises computer-readable program instructions in order to carry out a method for identifying an object according to claim 1.
